(19) United States
(12) Patent Application Publication
(10) Pub. No.: US 2008/0319826 A1
(43) Pub. Date: Dec. 25, 2008

(54) VIRTUAL MARKETS FOR SELECTING ANSWERS TO OPEN-ENDED QUESTIONS

(75) Inventors: Christina Ann LaComb, Schenectady, NY (US); Janet Arlie Barnett, Pattersonville, NY (US); Scott Charles Drake, Milton, GA (US); Steven Todd Sacks, New York, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/765,070

(22) Filed: Jun. 19, 2007

(51) Int. Cl. G06Q 99/00; G06F 17/00

(52) U.S. Cl. 705/10

(57) ABSTRACT

A virtual market system is used to rank-order answers to an open-ended question. A virtual market on which participants can trade securities representing answers to the open-ended question is used to gather information from the participants regarding each answer. Answers to be traded on the market may be provided by the participants, allowing for opinions to be expressed not only as to the relative worth of the securities on the market, but also as to which securities should be on the market.

### BACKGROUND

The systems and techniques described herein relate generally to gathering opinions from a population of people. More specifically, the systems and techniques relate to the use of a market-driven model to collect participant input for media content generation.

In many circumstances, it is desirable to collect information from a group of interested parties as to their opinion on an issue, or to their preference among several options. For instance, a manufacturer may wish to determine which features are most desirable to be added to a particular product offering, or a government official may wish to determine which issues are most important to the local constituency. Many existing techniques can be used to gather such information, such as polls, questionnaires, group meetings, requests for the group to send input, and so forth.

However, the collection of such information is subject to a number of factors that can skew the information received and bias the results in various ways. Markets are tools that are known to be able to account for many types of undesirable effects and gather effective information from a population of participants in the market. Historically, markets have been used to measure preferences among fixed choices or to establish continuously variable values, such as prices. Such techniques are not effective in gathering information that does not fall into such fixed forms.

Because of these and other limitations of previous information gathering techniques, there is a continuing need for systems and techniques that can be used to gather information that addresses questions that do not fall into such closed forms.

### SUMMARY

In accordance with one aspect of the systems and methods described herein, a method for rank-ordering a plurality of answers to an open-ended question using a virtual market is provided. A plurality of market participants are provided with an open-ended question to address, and are provided a plurality of answers to the question. Each answer is established as a security in a virtual market, and a value is attached to each security in that market. At least one of the answers is provided by a participant in the market. Trading of the securities by the participants if facilitated via the virtual market. The market allows the addition of an answer to, or the removal of an answer from, the plurality of answers to the question after a period of trading via the virtual market has taken place. A rank-order is established for the plurality of answers based upon the value associated with each security after a period of trading.

In other aspects of the systems and techniques herein, securities may be removed from the virtual market after a period of trading has taken place, based upon the value associated with that security. In yet other aspects, establishing a rank-order is performed by ranking each answer based on the volume-weighted-average-price of the security associated with that answer.

In some aspects, each participant initially has the same buying power in the virtual market. In other aspects, each participant's initial buying power in the virtual market is determined based upon the outcome of at least one previously run virtual market. In still other aspects, each participant is rewarded based upon the rank of the answers associated with the securities they own at the close of the virtual market, or upon the value associated with the securities they own at the close of the virtual market.

In particular aspects of the systems and techniques described herein, the open-ended question and the answers are related to media content. In some aspects the open-ended question and the answers are used to generate media content for distribution. In other aspects the answers with the best rank-order are reported as media content for distribution. In yet other aspects, each of the answers is associated with particular media content and the rank order of the answers is used to choose which media content to distribute.

In accordance with another aspect of the systems and methods described herein, a virtual market trading system for rank-ordering a plurality of answers to an open-ended question is created. The system includes a virtual market, and a user interface. The market is configured to facilitate trading of a plurality of securities by a plurality of market participants. Each security is associated with an answer to an open-ended question, and at least one of the answers is provided by a participant in the market. The market is also configured to allow the addition of a security to, or the removal of a security from, the plurality of securities after a period of trading via the virtual market has taken place. The user interface allows a participant to trade shares of any one of the plurality of securities to indicate an opinion regarding the answer associated with that security.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a system for gathering information related to the answers to a question in accordance with one embodiment of the present disclosure; and

FIG. 2 illustrates a flow diagram for a method for ranking the answers to a question associated with a market in accordance with an embodiment of the present disclosure.

### DETAILED DESCRIPTION OF EXEMPLARY EMBODIMENTS

As noted above, it would be desirable to use a market system to collect feedback and information from an appropriate group of interested individuals as a means to generate the best possible understanding of the relative interest of the group among a variety of choices. One way to capture the benefit of such a market system is to set up a way for a population of users to act as participants in a virtual market where they can trade securities that represent various possible opinions.

Such a system can be used for collecting a variety of different information for different purposes. For instance in one embodiment, such a system could be used to identify which portions of content that a media outlet might choose to broadcast would be of the most interest to the collective viewership. To accomplish this, a virtual financial market can be established to allow a large number of representative viewers to express their opinion by participating in a market that is established to answer a question, such as: “What current events topics should we cover in next week's news broadcast programming?” Multiple possible answers to the question can be established (in a variety of ways, discussed in greater detail below), and each possible answer to the question associated with this market can be represented by a security on the market.

At this point the market participants, which can include any interested viewer in one embodiment, may then trade shares of the various securities based on their preferences or relative affinities for each of the answers to the question represented by the securities in the market. In this case, each security will represent a particular current event topic that might be covered in an upcoming news broadcast. As the market runs over time, a measure of the relative value of each security can be used to understand which answers are more important to the participants. In one embodiment, a volume-weighted average price of the shares for a security may be used as an indicator of the collective interest of the participant population in a given answer to the question. In this way, the market can be used to reflect the desire of the viewership for different programming choices, and the media outlet can make appropriate programming choices based on this knowledge.

A particular embodiment of such systems and techniques involves markets that allow trading of securities that represent participants' opinion about prospective events. In such systems, the participants are providing information about their own opinions as to what they believe should occur. Gathering such prospective information can be especially effective when combined with an open-ended question. In such embodiments, the market can be used for not only collecting preference information, but can potentially be used for solicitation of possible answers to the question itself. By providing for a way to alter the securities available for trading on the market during the operation of the market, a system is provided that can not only be used to reflect variations in the relative value of various answers to the question, but can be used to reflect variations in the possible answers to the question as well.

As mentioned above, in particular embodiments of the system and techniques described herein the question to be addressed by the market may be an open-ended question. Such open-ended questions are generally characterized by being questions for which it is not possible for every answer to the question to be represented as a security in the market, or questions for which there may not be an objectively “correct” answer that can be determined during the run of the market. Such questions that lack correct answers can either be fundamentally subjective questions (e.g. “what is the most important reason why United and Continental Airlines should or should not merge”), or questions that will ultimately have a correct answer, but determination of that answer will either take place after the market has closed, or is subject to interpretation (e.g. “which energy company is best positioned to gain the most market share in 2007”). Because such open-ended questions may not have objectively “correct” answers available in the short-term, the value of securities in a market for such a question will depend upon the preferences of the participants in the marketplace.

Although, as discussed below, it is possible for securities to be added to the market or removed from the market during the market's operation, it is generally the case that for the market to be effective, an increase in the likelihood of one answer being the most valued answer must be reflected by a relative decrease in the value of other answers. So while the securities being traded need not span the entirety of the possible answers to the question, the answers should be structured such that they can compete with one another within the market.

In certain embodiments, a time limit or duration may be placed on a market, and/or a market may be checked periodically and/or after a certain time period. When a market is checked, answers with, for example, a highest volume-weighted-average-price over a certain period of trading, are considered the answers most important to the group. In certain embodiments, a certain predetermined number of answers may be selected as important or valuable to the target group. For example, five answers with the highest volume-weighted-average-price over the last five days of trading may be designated as the most significant answers.

As another example, all answers with a price over a certain threshold may be designated as the most important answers. In certain embodiments, answers are ranked according to gathered data, and a user or automated program may select from the ranked answers to take an appropriate action. For instance, a system may be configured to automatically queue up media programming corresponding to the most important answers received from a market that answers the question of “What programs would you most want to see next week on our network?”

In certain embodiments, since the market is operating in real-time or substantially real-time (e.g., with some inherent system processing/communication delay), changes in participant preferences and/or in an environment in which the answers are reflected in market prices. Thus, these systems and techniques can provide an interactive way for participants to set a vision for media products, or to express opinions on other questions, as discussed below.

In operation, a system administrator or other market operator establishes a particular question to be answered and sets up a market to answer that question. An initial list of answers to the question are established. In some embodiments, participants in the market are able to propose additional answers to the question and those answers may be added to the market as tradable securities. In some embodiments, only certain participants are able to propose additional answers, for example, those participants with proven records of successful participation in previous markets, or those participants with known expertise on the question at hand. In some embodiments, the system administrator must approve the introduction of a security for a participant-suggested answer before the answer will be available for trading by participants in the market, while in other embodiments, suggested answers may be available as tradable securities immediately upon suggestion.

In particular market embodiments, securities may be suggested by participants and added to the market during the operation of the market. That is, even though the market may already have been operating for a period of time, new securities may be added to the market to allow for gathering information related to newly proposed answers to the question.

Similarly, in some embodiments, securities may be removed from the market after the market is in operation. Such removal may be based upon the performance of the security on the market, for instance, based upon the volume of trades or upon the relative value of the security compared to the remainder of the market. Such removal may be automated in some embodiments, or may be mediated or approved by the market operator or system administrator in other embodiments.

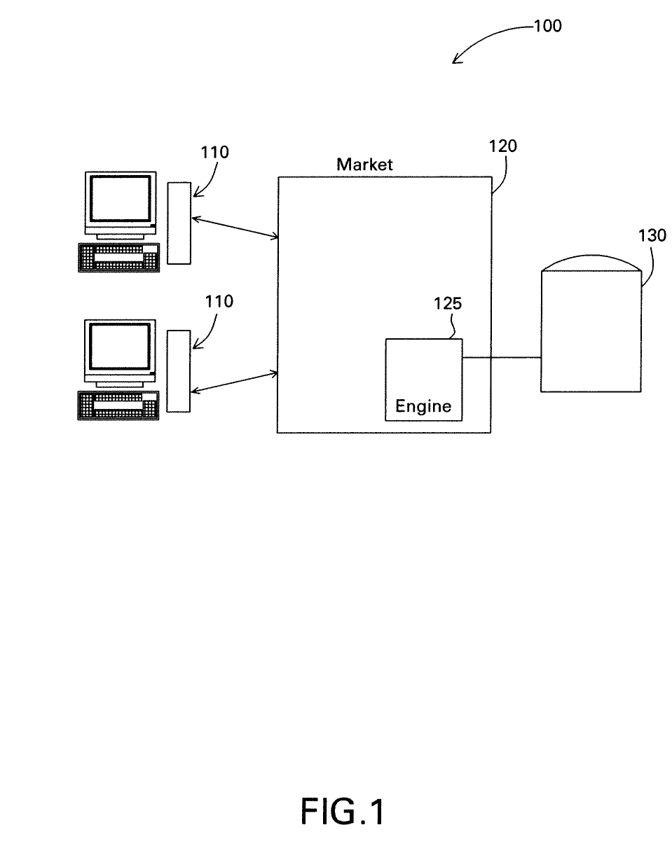

FIG. 1 illustrates one embodiment of a system 100 for gathering feedback regarding answers to a question. The system 100 includes one or more user interfaces 110, a market 120 and a back end processor 130. In certain embodiments, the elements of the system 100 may be implemented separately and/or combined in a variety of combinations. In certain embodiments, the system 100 may be implemented on a single computer, a local or wide area network, over the Internet, via a private network, etc. The components of the system 100 may be implemented in software, hardware and/or firmware, for example.

The user interface 110 allows a participant or other user to view current trading information for one or more securities included in the market 120. The user interface 110 may be configured for use through a variety of devices, including but not limited to: a personal computer, a mobile device (such as a cellular phone or PDA), a terminal connected to a server, or such other devices that would be considered appropriate to one of skill in the art. In one embodiment, the interface may include a web browser that is used to access a server that provides access to the market 120.

Using the interface 110, a participant may “trade” one or more securities (each of which represents a particular answer to the question being addressed by the particular market) and thereby contribute his or her feedback to the relative evaluation of the answers. A participant may “buy” a particular security to indicate his or her support for an answer, and may “sell” a security to decrease support or show a negative opinion regarding that answer. A degree or quantity by which a user buys or sells a security may be used to represent the strength of the user's opinion (e.g., strongly like an answer, strongly dislike an answer, like an answer, indifferent toward an answer, etc.).

In certain embodiments, a participant may be allowed to provide a certain amount of feedback (e.g., a user may be allocated a certain number of virtual “dollars” for use in trading of securities) to allocate among the traded answers as they desire. In some embodiments, each participant may be allocated the same amount of feedback, while in others some participants may be allowed more feedback in the form of more wealth to invest in a particular market. In still other embodiments, a participant may be limited in the total amount of value they are allowed to invest in a single security, or by other arrangements that those of skill in the art may recognize as being effective at preventing participants from engaging in behavior that skews the results of the market.

The market 120 accepts participant input via the user interface 110 (and possibly from the back end processor 130 as well) and uses the input to modify market data according to one or more rules in place for the market 120. Rules may be provided as defaults and/or provided as input from one or more administrators, developers, and/or users, for example. Data is processed by the market 120 and made available for display, storage, transfer, and/or further processing via the user interface 110 and/or back end 130.

The back end processor 130 receives data from the market 120 relating to securities being traded on the market 120, analysis data, and/or other user input, for example. The back end 130 may use market data to provide feedback and/or other input to software development, packaging and/or marketing, for example.

The market 120 may be run using a market maker engine. The engine 125 establishes the virtual market and trading capability and creates the simulated trading environment that allows the buying and selling of securities. Such an engine can be configured to allow for the immediate fulfilling of transactions requested by participants in one embodiment of the systems and techniques described. For example, for an answer having a security on the market, the engine offers participants the chance to purchase shares of the answer at an initial offering price. Although in one embodiment, the initial offering price of each security may be the same, it is not required to be so, and such initial offering prices may vary in other embodiments. In yet other embodiments, the initial price may remain undetermined initially, and the first transaction of a particular security may be used to establish the first price of the security.

The market engine 125 may be configured to allow trading of securities for a particular market (i.e. for answers to a particular question) for a fixed period of time, for instance, for nine days. It will be well appreciated that any other time period may be used as is appropriate for the desired level of participation and the desired use or urgency of a result. For example, for questions that are asked and reported on weekly, market runs of seven days may be the most desirable. Daily reporting may work best with runs of a single day. Questions that reflect issues of long-term interest or highly speculative questions may require longer runs.

In one embodiment, such time at which the market will be closed is not shared with the participants. At the end of the trading period, the market is closed and the participant with the most virtual value associated with their securities in the market may be declared the ‘winner’ of that particular market run.

It will be understood that the market need not operate for a fixed period of time, nor need the participants be unaware of the closing time of the market. However, in various embodiments it may be desirable to prevent participants from having too much information regarding the closing of the market to avoid tournament behavior. In some embodiments, the market may be run until a predetermined condition is reached. Such conditions may be determined on the basis of the volume of trades of securities on the market, the relative values of securities on the market, or the rate at which the relative values of the securities on the market are changing.

The market engine 125 may operate in a similar manner to an actual stock market. ‘Bid’ and ‘ask’ prices may be maintained for each security in one embodiment, and the engine may track a volume-weighted average price (VWAP) for each security. The VWAP represents the stock price weighted by the shares held at each price. The engine is used to satisfy each buy/sell command automatically in one embodiment, so that trades do not actually occur between participants directly, but rather occur directly with the engine.

The engine 125 can track the buy and sell prices for each security, the change in price (both as an absolute value and as a percentage of current value), the volume of shares sold and the VWAP. Through the interface, each participant can choose to buy and sell various amounts of each security and get a view of their current available cash, value held and available securities.

Once trading has begun and the market 120 is open, the engine 125 can be used to periodically calculate the appropriate changes in the bid and ask prices for the securities. In one embodiment the engine adjusts the prices after each trade, whether that trade is a buy or a sell order. In this way, the security price will change after each trade regardless of the number of shares traded or the existence of a corresponding trade that matches the requested trade. Various techniques for adjusting the bid and ask prices of a security based on its trading activity are known in the art, and the engine 125 may be configured to apply one or more of these techniques as appropriate during operation of any given market.

The market engine 125 may operate in the above described manner until such time as the market is closed. Once the market has closed, a rank-order for the securities on the market may be established. In one embodiment, the rank order may be determined based upon the relative VWAP of each security, although those of skill in the art will recognize that there are other rankings that may be useful for certain applications.

In order to facilitate the operation of the market and to provide input from the participants to the engine 125, a user interface may be created that allows for the presentation of various market related information to the participants, and allows for the participants to place orders to buy or sell the securities within the market.

Such an interface may provide market information such as those securities that are most rapidly changing value, the current value of the participant's portfolio of securities, and other information as is ordinarily used in interacting with a financial or other marketplace, including a participant's trading rank, the number of different securities held, a trading history, a cash balance available for further trading, etc.

The interface may also provide a way for a user to suggest an additional answer to the question (as discussed above), or to access news or information about the question or the securities traded in the market. In various embodiments, such information may be provided only prior to the opening of a particular market, or may be made available continuously during operation of a market. In addition, such content may be updated periodically in some embodiments. Such updates may be made only prior to the opening of a market, during the time when a market is open for trading, or both. Links to relevant information may be provided in some embodiments, and interactive forums for the exchange of information between participants may also be made available in other embodiments.

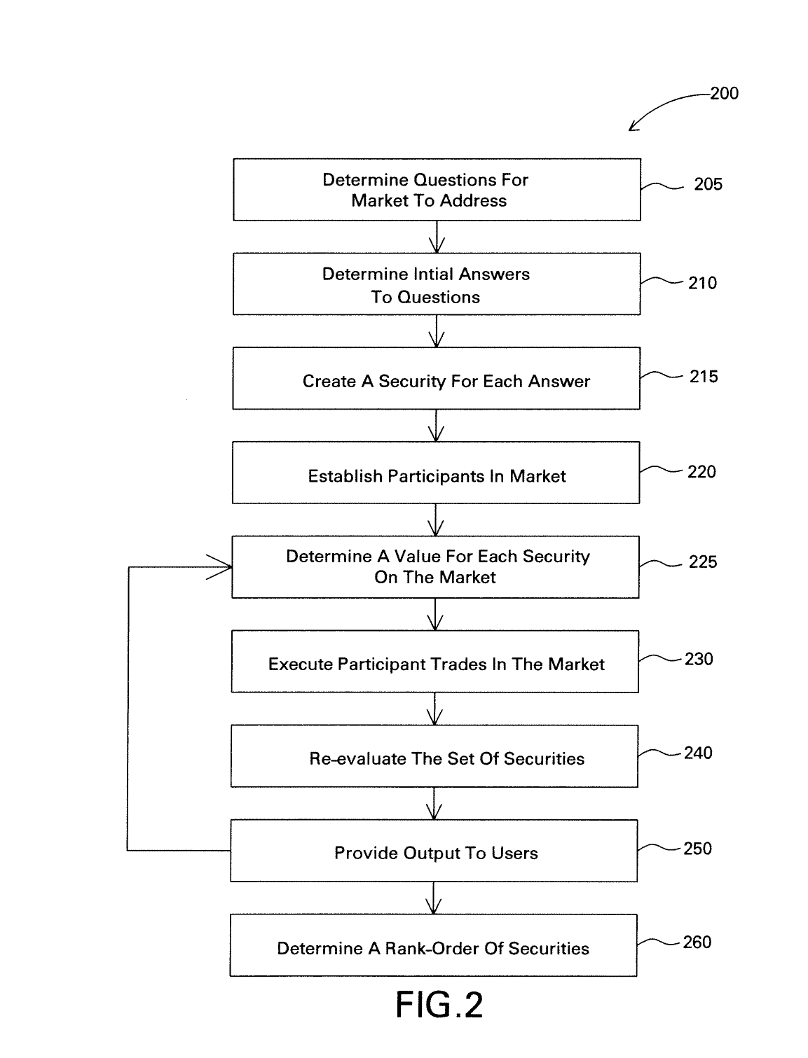

FIG. 2 illustrates a flow diagram for a method 200 for ranking answers to a question using an information market in accordance with an embodiment of the systems and techniques herein. At step 205, the question that the market will address is determined. For example, the question could be “Who do you think should succeed the current UN Secretary General”, and the answers could represent various possible successors. At step 210, an initial set of answers to the question are determined. At step 215, a security associated with each answer to the question is created and established in a virtual market.

At step 220, the body of participants for the market are determined. The selection of eligible participants may be done using a variety of techniques. In one embodiment, participants may be selected by the owner of the market for their known expertise or interest in the question at hand. For example, a group of experts in international affairs might be selected as the body of participants for the question regarding the UN Secretary General mentioned above. In other embodiments, participation in the market may be made available to a large group of invitees on the basis of participation in previously run markets, or by some measure of successful performance in previously run markets. For instance, only those who held securities that were highly ranked in related previously run markets might be eligible to participate. In yet other embodiments, participants may be anyone who is willing to register and participate. This step may be performed repeatedly during the execution of the market as well, allowing additional participants to express an opinion through the market.

In step 225, a market value is established, for each security on the market. As noted above, different techniques may be used for the initial determination of the market value of a security, and for subsequent determinations of the value after the market is in operation.

For instance, for determining the initial value of a security, a uniform value may be applied to every security on the market in one embodiment. In other embodiments, initial values may be determined based on source of information outside the market, such as expert opinion, the results of a previously run market, or results of a public poll. In still other embodiments, a security's initial value may be established to remain undetermined until an initial trade is made of that security once the market opens.

Once the market is running, the technique used to establish the value of a security may be based upon the trading activity of that security. As noted above, various techniques are available to allow for adjustment of the price of a security during the operation of a market based upon the trading activity. Such techniques can be applied as necessary during the operation of a market, and need not be the same techniques used for determining the initial price (if any) of the security.

During operation of the market 120, the users may execute trades of the securities in the marketplace at step 230, and their input becomes part of the market. For example, one or more of the participants may buy or sell one or more securities on the marketplace. In certain embodiments, participants may be initially allotted a specific amount of trading dollars with which to provide feedback through trading on the market.

In certain other embodiments, participants may become eligible for additional buying power in various ways. For instance, a series of markets may be configured such that value acquired in previously run markets may be used in a current market. In some embodiments, such value may only be used if the markets are related in some way, for instance, if they address questions whose answers are related or that are in fields that benefit from similar expertise. Such systems allow for successive markets to help establish empirically those participants who have proved themselves to have expertise in the relevant field.

At step 240, the securities on the market are reevaluated. Such reevaluation may include altering the price of each security on the basis of the trades executed in that security, as well as evaluating whether or not all existing securities should remain on the market, or whether they should be dropped from further trading. In addition, the evaluation to add additional securities may be made in this step. In one embodiment, the market values of the various securities on the market may be adjusted based on the activities of the participants. For example, as one or more securities are bought and sold, the share price of each security (and accordingly the relative rank or importance of the answer represented by the security) is adjusted based on trading activity.

At step 250, feedback is provided to an external or back-end system 130 regarding answer ranking and/or other market status information. For example, a ranking of answers may be provided to an operator of the market for use in practical decision making. As noted above, this could include the use of the relative importance of the answers for guidance in choosing what actions to take with regard to future activities.

Another possible application is to present the results of questions of interest (as determined by the market) on a regular basis as media content. For instance, the results of a daily question could be presented after allowing the market to collect the opinions of participants for day. Such content could include not only the answer or answers which were determined to have the highest rank, but also the most profitable game participants that owned shares of the highest ranked securities.

Step 250 may also include the delivery of such information for the securities as trading frequency, change in market value, share price, trading volume, volume-weighted average price (VWAP), etc. to an external system for examination by the market owner. Such feedback may be provided automatically and/or upon request, in varying embodiments. Other varying embodiments may provide feedback at a close of trading on a given question, after a particular interval of trading has taken place, on a recurring periodic basis, or such other timings as will be understood to one of skill in the art. Such feedback may take various forms that include but are not limited to: logs, databases of information, alerts, electronic messages, documentation, etc.

Alternatively and/or in addition, feedback may be provided to an electronic processing system for automated display in various media. This could include, in various embodiments, the inclusion of such information in a running ticker, similar to those seen for reporting on the NASDAQ or NYSE markets, or the periodic display during a news program of the relative ranks of various securities in a particular market.

Such a process as described above in steps 225 to 250 may be repeated as long as the market is open and trading is allowed. Once the market is closed, a rank-order of the securities currently on the market may be performed in step 260.

Additional features of the systems and techniques described herein may include the collection and presentation of relevant information to the market participants. Such information may be gathered and collected from external news sources, either automatically or by the system administrator, and presented or otherwise made available in some form to the market participants through the interfaces described above. The system may also be configured to provide a message board or other interactive communications system that allows for the market participants to exchange information directly with one another during the operation of the market.

Such systems can provide a medium for information that is potentially relevant to the question being addressed by the market to be provided to and commented upon by the market participants. Such flow of information among the market participants may result in more effective trading strategies by the participants, and a more accurate reflection of the collective opinion of the participants in the values of the traded securities.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

It will also be understood that multiple markets addressing different (although possibly related) questions may be run simultaneously. In one embodiment, each market is run entirely independently of the others. Such systems may make use of separate engines and separate pools of virtual value. In other embodiments, questions that are related in some way (e.g. by subject area, by market owner, or by participant pool) may be configured to allow for value (e.g. virtual cash) generated in one market to be used in the related markets. Although such a configuration may be effective for allowing someone to demonstrate expertise more rapidly and thereby to exert a greater influence on the outcome of the market, sharing value between markets can also induce participant behavior designed to enhance their influence in one market at the expense of their value in the related market. For example, trading activity in one market might be driven by cash-flow needs, rather than by a true opinion on that question, in order to use that cash in another market that a participants is also trading on.

In addition to determining those securities that have the highest rank, the market can also be used to provide relative rankings of the participants, or to provide various forms of reward to the participants on the basis of their performance on the market, or on a group of markets.

Such rewards may take a variety of forms that can include without limitation: the inclusion of the names of those most highly ranked participants or virtually wealthiest participants in media that is distributed by the market owner; allowing the participants (or those participants who are most highly ranked or highly valued in a particular market) to carry their wealth from one market over into other markets (either future markets, or related concurrent markets); providing actual prizes of real-world value on the basis of the market performance of the participants, such as a prize provided by a sponsor of the question being addressed by the market; and getting their answer used as the basis for decision making by the market owner.

In addition, the determination of the participants who get rewarded can be handled in a variety of ways. These can include without limitation; rewarding those participants with the highest ownership stake in the most highly ranked securities; rewarding the participants who have the highest value in a particular market or in a set of related markets; and rewarding participants based on a lottery system that is weighted to allow a greater chance of wining based upon the relative success of the participant using a variety of measures.

Thus, certain embodiments provide a feedback tool that allows a potentially large, geographically dispersed group of users to provide information to the owner of a market as to the relative importance of different answers to a question of interest to the market owner. Certain embodiments allow participants to consider importance of answers within the context of the importance of those features to other users. Certain embodiments allow market operator to assign particular weight or priority to opinions of one or more select subsets of the participants, based on one or more criteria such as previous performance in related virtual markets, participants identify, expertise and/or other differentiating factors. Certain embodiments provide a technical effect of generating feedback regarding one or more answers to an open-ended question via a market-based trading model.

Several embodiments are described above with reference to drawings. These drawings illustrate certain details of specific embodiments that implement the systems and methods and programs described herein. However, describing these systems and techniques with drawings should not be construed as imposing on the systems and techniques any limitations associated with features shown in the drawings. As noted above, the embodiments of these systems and techniques may be implemented using an existing computer processor, or by a special purpose computer processor incorporated for this or another purpose, or by a hardwired system.

As noted above, embodiments within the scope of the description include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the methods described above are presented in the general context of steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Various embodiments of the systems and techniques above may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the systems and techniques above might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The various embodiments of market systems described above thus provide a way to allow a population of participants in a market to indicate their collective expertise on a question that the market is designed to address. These techniques and systems also allow for effective flow of information among participants, both through the market and through the associated interactive forums, and also allow for appropriate incentives to produce effective participation in the market by the participants.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the method of selecting the participants' initial buying power in a market described with respect to one embodiment can be adapted for use with the ability of the participants to introduce additional securities described with respect to another. Similarly, the various features described, as well as other known equivalents for each feature, can be mixed and matched by one of ordinary skill in this art to construct additional systems and techniques in accordance with principles of this disclosure.

Although the systems and methods herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

What is claimed is:

1. A method for rank-ordering a plurality of answers to an open-ended question using a virtual market, the method comprising:
providing a plurality of market participants with an open-ended question;
providing a plurality of answers to the question, wherein at least one of the answers to the open-ended question is provided by the market participants;
establishing each answer as a security in a virtual market;
attaching a value to each security in the virtual market;
facilitating trading of the securities by the participants via the virtual market; and
establishing a rank-order for the plurality of answers based upon the value associated with each security after a period of trading.

2. The method of claim 1 wherein facilitating trading of the securities includes informing the participants of when trading on the virtual market will be closed.

3. The method of claim 1 wherein facilitating trading of the securities includes closing the virtual market without informing the participants in advance.

4. The method of claim 1 wherein facilitating trading of the securities includes closing the virtual market based upon the relative values of the securities being traded on the market.

5. The method of claim 1 wherein establishing a rank-order comprises ranking each answer based on the volume-weighted-average-price of the security associated with that answer.

6. The method of claim 1 wherein each participant initially has the same buying power in the virtual market.

7. The method of claim 1 wherein each participant's initial buying power in the virtual market is determined based upon the outcome of at least one previously run virtual market.

8. The method of claim 1 wherein each participant is rewarded based upon the rank of the answers associated with the securities they own at the close of the virtual market.

9. The method of claim 1 wherein each participant is rewarded based upon the value associated with the securities they own at the close of the virtual market.

10. The method of claim 1 wherein the open-ended question and the answers are related to media content.

11. The method of claim 10 wherein the open-ended question and the answers are used to generate media content for distribution.

12. The method of claim 10 wherein the answers with the best rank-order are reported as media content for distribution.

13. the method of claim 10 wherein each of the answers is associated with particular media content and the rank order of the answers is used to choose which media content to distribute.

14. A virtual market trading system for rank-ordering a plurality of answers to an open-ended question, the system comprising:
a virtual market configured to facilitate trading of a plurality of securities by a plurality of market participants, each security being associated with an answer to an open-ended question, and at least one of the answers being provided by one of the plurality of market participants; and
a user interface allowing a participant to trade shares of any one of the plurality of securities to indicate an opinion regarding the answer associated with that security.

15. The system of claim 14 wherein the user interface provides the participants with information regarding when the virtual market will be closed.

16. The system of claim 14 wherein the virtual market is configured to close trading without informing the participants in advance.

17. The system of claim 14 wherein facilitating trading of the securities includes closing the virtual market based upon the relative values of the securities being traded on the market.

18. The system of claim 14 wherein the user interface provides each participant with a specific amount of buying power that can be used to purchase securities in the virtual market.

19. The system of claim 18 wherein each participant initially has the same buying power.

20. The system of claim 18 wherein each participant's initial buying power in the virtual market is determined based upon the outcome of a previously run virtual market.

21. The system of claim 18 wherein each participant is rewarded based upon the value associated with the securities they own at the close of the virtual market.

22. The system of claim 19 wherein each participant is rewarded based upon the rank of the answers associated with the securities they own at the close of the market.

23. The system of claim 14 wherein the virtual market is configured to provide a rank-order to the answers associated with the securities in the virtual market.

24. The system of claim 22 wherein the rank-order for the answers is based on the volume-weighted-average-price of the security associated with that answer.

25. The system of claim 14 wherein the open-ended question and the answers are related to media content.

26. The system of claim 25 wherein the open-ended question and the answers are used to generate media content for distribution.

27. The system of claim 25 wherein the answers with the best rank-order are reported as media content for distribution.

28. The system of claim 25 wherein each of the answers is associated with particular media content and the rank order of the answers is used to choose which media content to distribute.
